(19) United States
(12) Patent Application Publication
(10) Pub. No.: US 2025/0053376 A1
(43) Pub. Date: Feb. 13, 2025

(54) APPARATUS, METHOD AND COMPUTER PROGRAM

(71) Applicant: Nokia Technologies Oy, Espoo (FI)

(72) Inventor: Ioannis MOUROULIS, Athens (GR)

(21) Appl. No.: 18/798,937

(22) Filed: Aug. 9, 2024

(30) Foreign Application Priority Data
Aug. 11, 2023 (GB) 2312308.6

(51) Int. Cl. G06F 7/08

(52) U.S. Cl. CPC G06F 7/08

(57) ABSTRACT

Various example embodiments of the subject disclosure relate to apparatuses, methods and computer programs. There is provided, for example, an apparatus including means for determining at least one sorted list of elements from a plurality of lists of elements and means for providing information including the at least one sorted list to a network function, the information including an indication of the sorted list.

### TECHNICAL FIELD

Various example embodiments of the subject disclosure relate to methods, apparatus, systems and computer programs, and in particular (but not exclusively) to the support of non-linear search algorithms in NF profile lists.

### BACKGROUND

A communication system can be seen as a facility that enables communication sessions between two or more entities, such as user terminals, base stations and/or other nodes by providing carriers between the various entities involved in the communications path. A communication system can be provided for example by means of a communication network and one or more compatible communication devices. The communication sessions may comprise, for example, communication of data for carrying communications, such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification, which sets out what the various entities associated with the system are permitted to do and how that should be achieved. Communication protocols and/or parameters that can be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

Several aspects of the various examples described in the subject disclosure are detailed as follows:

In a first aspect, there is provided an apparatus comprising means for determining at least one sorted list of elements from a plurality of lists of elements and means for providing information comprising the at least one sorted list to a network function, the information comprising an indication of the sorted list.

The information may comprise an indication of a sort order of the sorted list.

The elements of the sorted list may comprise a structured data type comprising a plurality of attributes and the indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

A sort order may be preconfigured at the apparatus.

The apparatus may comprise a network function service producer and the network function may comprise a network repository function.

The apparatus may comprise a network repository function and the network function may comprise a network function service consumer or service communication proxy.

The indication of the sorted list may comprise a javascript object notation, JSON, pointer.

The information may comprise a network function profile.

In a second aspect, there is provided an apparatus comprising means for receiving information at a network function, the information comprising at least one sorted list of elements and an indication of the sorted list and means for performing a search of the elements of the sorted list using a non-linear search algorithm.

The information may comprise an indication of a sort order of the sorted list.

The elements of the sorted list may comprise a structured data type comprising a plurality of attributes. The indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

The apparatus may comprise a network repository function and the apparatus may comprise means for receiving the information from a network function service producer.

The apparatus may comprise a network function service consumer or service communication proxy and the apparatus may comprise means for receiving the information from a network repository function.

The indication of the sorted list may comprise a javascript object notation, JSON, pointer.

The information may comprise a network function profile.

In a third aspect, there is provided a method comprising determining at least one sorted list of elements from a plurality of lists of elements and providing information comprising the at least one sorted list to a network function, the information comprising an indication of the sorted list.

The information may comprise an indication of a sort order of the sorted list.

The elements of the sorted list may comprise a structured data type comprising a plurality of attributes and the indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

A sort order may be preconfigured at the apparatus.

The method may be performed at an apparatus comprising a network function service producer and the network function may comprise a network repository function.

The method may be performed at an apparatus comprising a network repository function and the network function may comprise a network function service consumer or service communication proxy.

The indication of the sorted list may comprise a javascript object notation, JSON, pointer.

The information may comprise a network function profile.

In a fourth aspect, there is provided a method comprising receiving information at a network function, the information comprising at least one sorted list of elements and an indication of the sorted list and performing a search of the elements of the sorted list using a non-linear search algorithm.

The information may comprise an indication of a sort order of the sorted list.

The elements of the sorted list may comprise a structured data type comprising a plurality of attributes. The indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

The method may be performed at an apparatus comprising a network repository function and the method may comprise receiving the information from a network function service producer.

The method may be performed at an apparatus comprising a network function service consumer or service communication proxy and the method may comprise receiving the information from a network repository function.

The indication of the sorted list may comprise a javascript object notation, JSON, pointer.

The information may comprise a network function profile.

In a fifth aspect, there is provided an apparatus comprising at least one processor, and at least one memory storing instructions, that when executed by the at least one processor, cause the apparatus at least to determine at least one sorted list of elements from a plurality of lists of elements and provide information comprising the at least one sorted list to a network function, the information comprising an indication of the sorted list.

The information may comprise an indication of a sort order of the sorted list.

The elements of the sorted list may comprise a structured data type comprising a plurality of attributes and the indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

A sort order may be preconfigured at the apparatus.

The apparatus may comprise a network function service producer and the network function may comprise a network repository function.

The apparatus may comprise a network repository function and the network function may comprise a network function service consumer or service communication proxy.

The indication of the sorted list may comprise a javascript object notation, JSON, pointer.

The information may comprise a network function profile.

In a sixth aspect, there is provided an apparatus comprising at least one processor, and at least one memory storing instructions, that when executed by the at least one processor, cause the apparatus at least to receive information at a network function, the information comprising at least one sorted list of elements and an indication of the sorted list and perform a search of the elements of the sorted list using a non-linear search algorithm.

The information may comprise an indication of a sort order of the sorted list.

The elements of the sorted list may comprise a structured data type comprising a plurality of attributes.

The indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

The apparatus may comprise a network repository function and the apparatus may be caused to receive the information from a network function service producer.

The apparatus may comprise a network function service consumer or service communication proxy and the apparatus may be caused to receive the information from a network repository function.

The indication of the sorted list may comprise a javascript object notation, JSON, pointer.

The information may comprise a network function profile.

In a seventh aspect, there is provided a computer readable medium comprising instructions which, when executed by an apparatus, cause the apparatus to perform at least the following determining at least one sorted list of elements from a plurality of lists of elements and providing information comprising the at least one sorted list to a network function, the information comprising an indication of the sorted list.

The information may comprise an indication of a sort order of the sorted list.

The elements of the sorted list may comprise a structured data type comprising a plurality of attributes and the indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

A sort order may be preconfigured at the apparatus.

The apparatus may comprise a network function service producer and the network function may comprise a network repository function.

The apparatus may comprise a network repository function and the network function may comprise a network function service consumer or service communication proxy.

The indication of the sorted list may comprise a javascript object notation, JSON, pointer.

The information may comprise a network function profile.

In an eighth aspect, there is provided a computer readable medium comprising instructions which, when executed by an apparatus, cause the apparatus to perform at least the following receiving information at a network function, the information comprising at least one sorted list of elements and an indication of the sorted list and performing a search of the elements of the sorted list using a non-linear search algorithm.

The information may comprise an indication of a sort order of the sorted list.

The elements of the sorted list may comprise a structured data type comprising a plurality of attributes.

The indication of the sort order may comprise an indication of the order the attributes of the structured data type are considered in the sorted list.

The structured data type may comprise at least one of a map or an array.

When the structured data type comprises a map, the elements may be sorted in ascending or descending order based on a key of the map.

When the structured data type is an array, the elements of the array may be simple data types and the elements may be sorted in ascending or descending order.

When the structured data type is an array, the elements of the array may comprise a further structured data type and the elements may be sorted in ascending or descending order based on the indication of the sort order.

The indication of the sort order may indicate that the array is used for sorting.

The indication of the sort order may comprise an indication that the order is ascending or descending.

The apparatus may comprise a network repository function and be caused to perform receiving the information from a network function service producer.

The apparatus may comprise a network function service consumer or service communication proxy and be caused to perform receiving the information from a network repository function.

The indication of the sorted list may comprise a javascript object notation, JSON, pointer.

The information may comprise a network function profile.

In a ninth aspect, there is provided a non-transitory computer readable medium comprising program instructions for causing an apparatus to perform at least the method according to the third or fourth aspect.

As provided above, several different example embodiments have been described. It should be appreciated that further example embodiments may be provided by the combination of any two or more of the example embodiments described herein.

### BRIEF DESCRIPTION OF THE DRAWINGS

Some example embodiments will now be described, by way of non-limiting and illustrative example only, with reference to the accompanying drawings in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows an example of a 5GC SBA architecture;

FIG. 5 shows an example signalling flow for an NF discovery procedure between an NF Service Consumer and an NRF;

FIG. 6 shows a flowchart of a method according to an example embodiment;

FIG. 7 shows a flowchart of a method according to an example embodiment;

FIG. 8a shows a schematic diagram of a linear search in a non-sorted array;

FIG. 8b shows a schematic diagram of a non-linear search in a sorted array;

FIG. 9a shows a schematic diagram of a linear search in a non-sorted array;

FIG. 9b shows a schematic diagram of a non-linear search in a sorted array.

### DETAILED DESCRIPTION

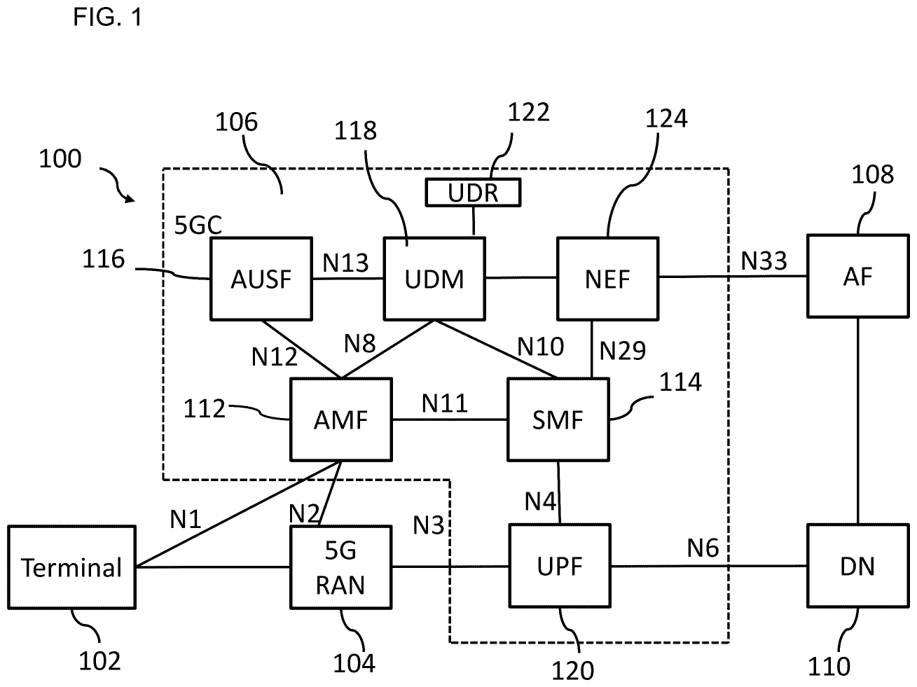

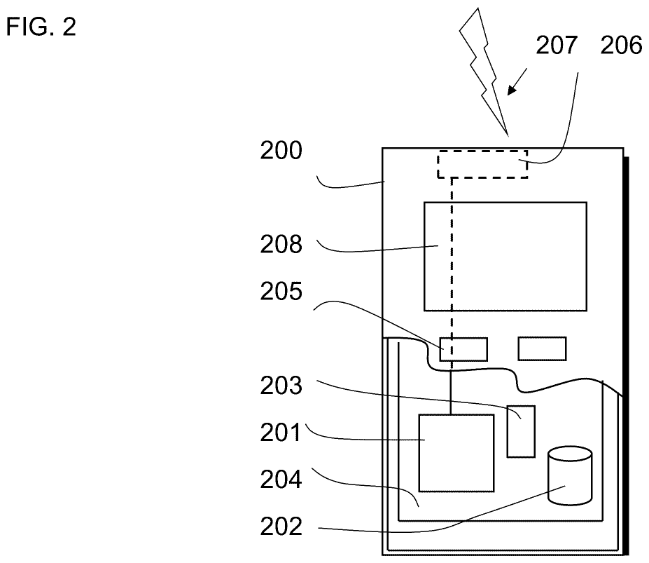

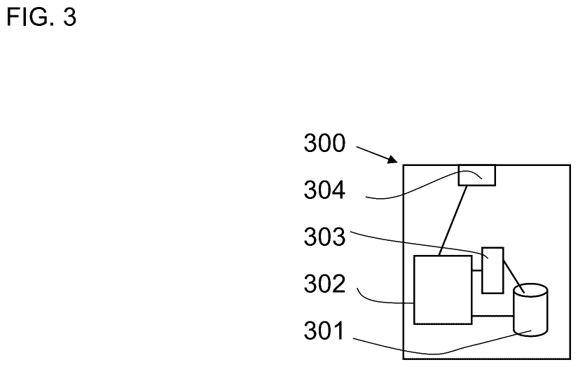

Before explaining in detail the various example embodiments, certain facets of a wireless communication system and mobile communication devices are briefly explained with reference to FIG. 1, FIG. 2 and FIG. 3 to assist in understanding the technology underlying the described example embodiments.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QOS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV), which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications, this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

An example mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting and illustrative examples comprise a mobile station (MS) or mobile device, such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices, such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications, such as voice, electronic mail (email), text message, multimedia and so on. Users may thus be offered and provided numerous services via their communication devices. Non-limiting and illustrative examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant components can be provided on an appropriate circuit board and/or in chipsets. This feature is denoted by reference 204. The user may control the operation of the mobile device by means of a suitable user interface, such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node, such as an MME or Serving Gateway (S-GW) or Packet Data Network Gateway (P-GW), or a core network function, such as AMF/SMF, or a server or host. The method may be implemented in a single control apparatus or across more than one control apparatus. The control apparatus may be integrated with or external to a node or module of a core network or RAN. In some example embodiments, base stations comprise a separate control apparatus unit or module. In other example embodiments, the control apparatus can be another network element, such as a radio network controller or a spectrum controller. In some example embodiments, each base station may have such a control apparatus as well as a control apparatus being provided in a radio network controller. The control apparatus 300 can be configured to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

The 5GC (5G Core network) has been defined as a Service Based Architecture (SBA), with NF service producers exposing services to NF service consumers. NF service producers register their NF profile in a Network Repository Function (NRF). The NF profile contains NF level specific information and the list of NF service instances supported by the NF, with their associated attributes.

NF Service consumers or Service Communication Proxies (SCP) discover NF service producers by performing an NF Discovery procedure towards the NRF with query parameters describing the services or properties of the NF service producers they wish to discover. The NRF returns the NF profiles of candidate NF service producers matching the query parameters in the response. An NF Discovery response will typically contain NF profiles of multiple candidate producers.

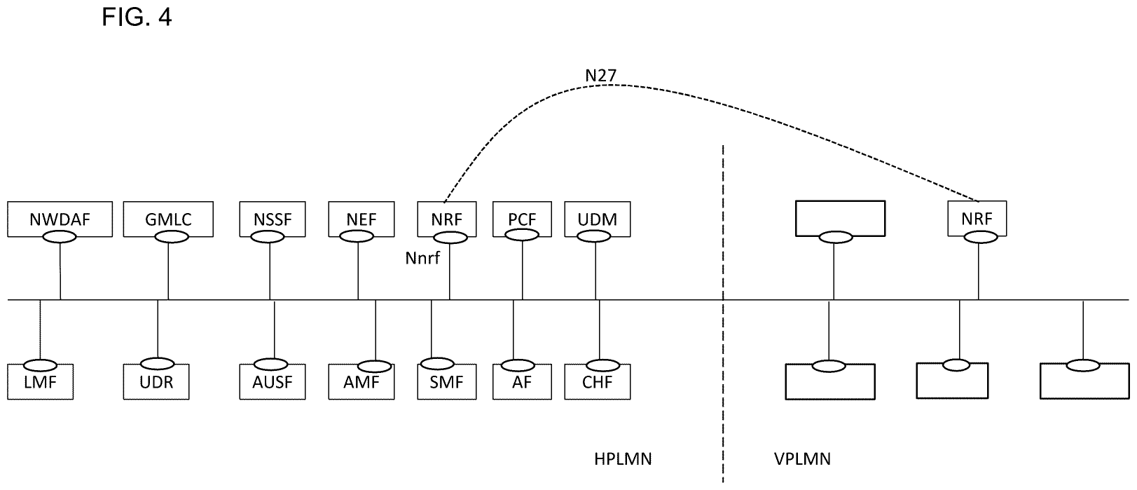

FIG. 4 shows an example of a 5GC SBA for a HPLMN. The interface N27 with a corresponding NRF in a VPLMN is also shown.

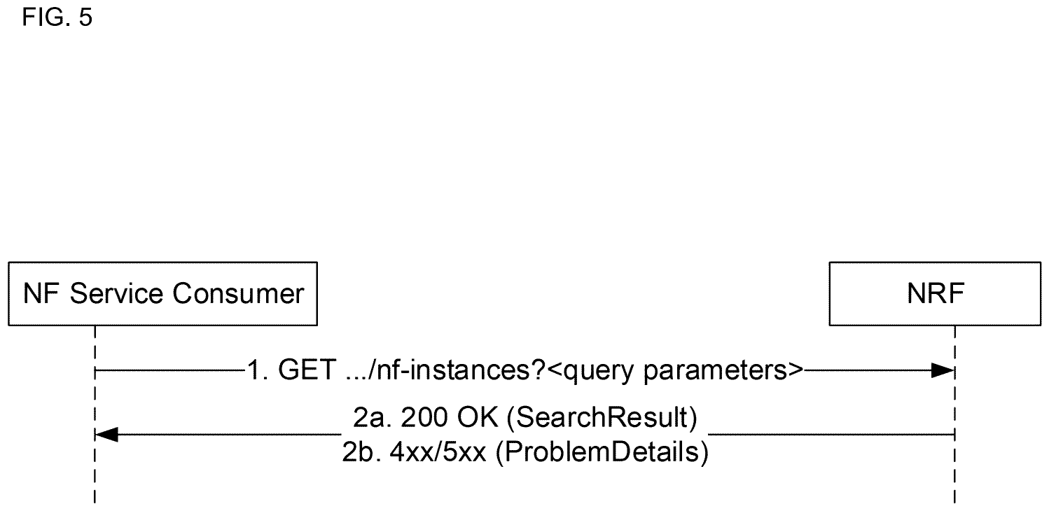

FIG. 5 shows a signalling diagram for an NF discovery procedure by an NF service consumer with an NRF. The NF service consumer sends a request for NF instances with query parameters and the NRF responds with a search result based on the query parameters.

The NRF API interface NFProfiles include list attributes that may contain several thousand elements describing the properties of the Network Functions. The list attributes may be, e.g., maps or arrays. The maps or arrays may be nested, e.g., the elements of the map or array comprise further maps or arrays.

For example, an AMF may serve in the order of thousands of Slices, and tenths of thousands of TAIs, an SMF or a UPF may serve in the order of thousands of Slices, DNNs and TAIs and a UDM may serve in the order of thousands of SUPI Ranges etc.

When an NRF, or an NF/SCP, with cached NFProfiles needs to check whether an NFProfile matches a selection criterion that is included in a list, it uses linear/sequential search algorithms as the elements in the list are placed with no predefined order. However, linear/sequential search may be computationally intense. On average, 50% of the list will be traversed when the list in the NFProfile includes the selection criterion. 100% of a list will be traversed (in vain) when the NFProfile does not support the selection criterion.

While some operations in certain APIs may also use very large lists (e.g., the N2Information TransferReqData JSON body may include an array with tenths of thousands of Tracking Areas), the problem may be more apparent in the NFProfiles used on the NRF API as searches there are much more common.

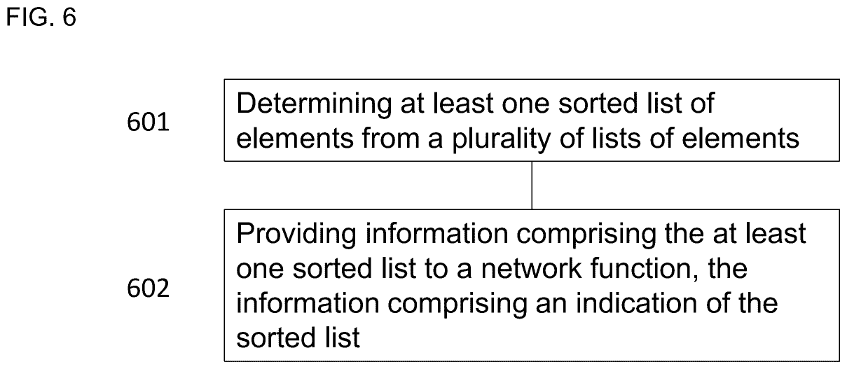

FIG. 6 shows a method according to an example embodiment. The method may be performed at an apparatus comprising a network function, such as a network function service producer or an NRF. In some example embodiments, the apparatus may be configured to operate as the network function service producer. For instance, the apparatus may be configured to perform one or more functions of the network function service producer. In some example embodiments, the apparatus may be configured to operate as the NRF. For instance, the apparatus may be configured to perform one or more functions of the NRF.

In 601, the method comprises determining at least one sorted list of elements from a plurality of lists of elements.

In 602, the method comprises providing information comprising the at least one sorted list to a network function, the information comprising an indication of the sorted list.

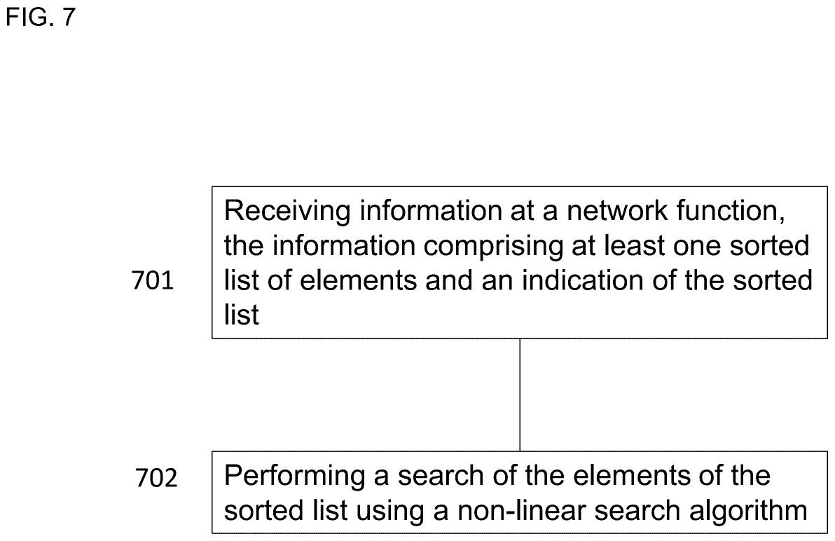

FIG. 7 shows a flowchart of a method according to an example embodiment.

In 701, the method comprises receiving information at a network function, the information comprising at least one sorted list of elements and an indication of the sorted list.

In 702, the method comprises performing a search of the elements of the sorted list using a non-linear search algorithm.

The network function to which the information is provided in the methods described with reference to FIG. 6 and FIG. 7 may be an NRF, a network function service consumer or an SCP.

The information may comprise a profile, e.g., an NFProfile.

The method may allow NFs (e.g., NF service producers or NRFs) to sort the elements of certain lists of their NFProfile so as to enable (or otherwise facilitate) NRFs, SCPs or other NFs to search in the lists using non-linear algorithms (e.g., but not limited to, binary, interpolation or jump search).

In an example embodiment, an NF provides an indication of the sorted list in the NFProfile (for example, an indication of which of the lists of the Profile are sorted). Non-linear search algorithms can thus be applied to that sorted list.

Usage of non-linear search may decrease the number of steps to find a match, or deduce that the NFProfile is a non-match, since the number of steps grows logarithmically with the number of elements included in the list, instead of linearly as in the case of sequential search.

For example, if an NFProfile\sNssais contains 4096 Slices and we want to find out whether it includes a specific slice, if the list is sorted, we can apply, e.g., binary search, and find out if the slice is included on average in 12 steps (i.e., 212). If the list is not sorted, we have to apply sequential search and on average will need 2048 steps if the slice is included, or 4096 steps if the slice is not included.

In this example, by using sorted lists and non-linear search on average, results can be provided with 0.6% of the steps when the slice is included, and 0.3% of the steps when the slice is not included.

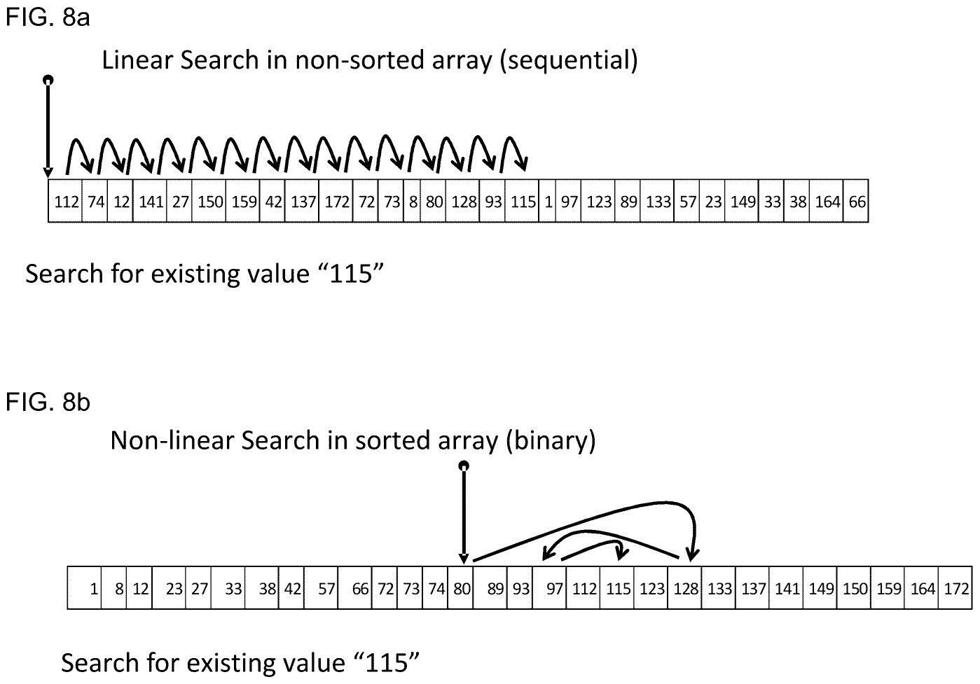

FIG. 8a depicts an example of linear search in a non-sorted list and FIG. 8b depicts an example of a non-linear search within a sorted list when the search value is included in the list.

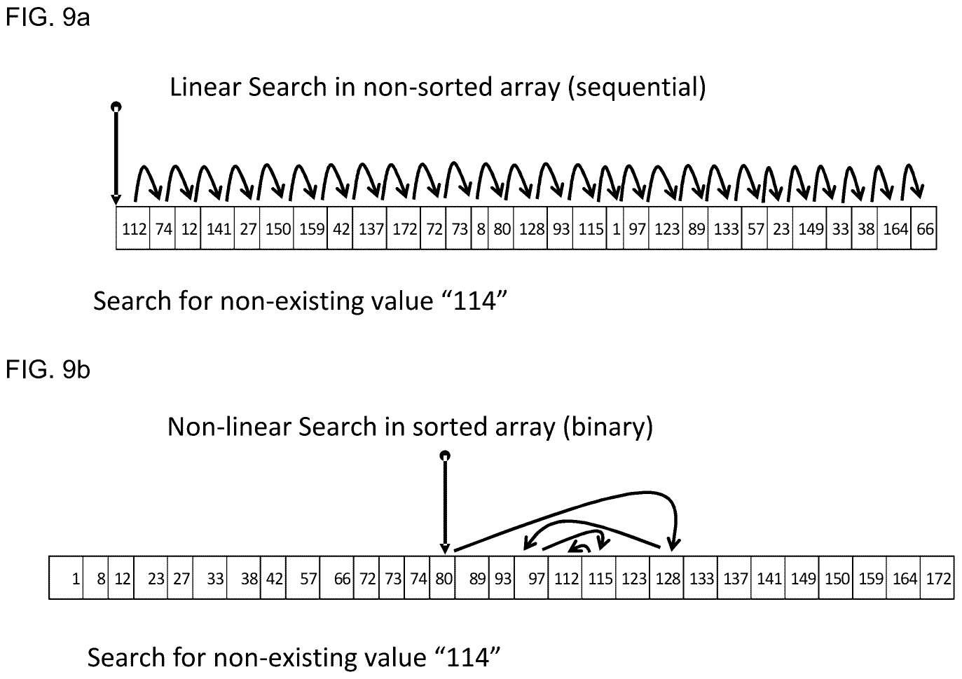

FIG. 9a depicts an example of linear search in a non-sorted list and FIG. 9b depicts an example of a non-linear search within a sorted list when the search value is not included in the list.

The information may comprise an indication of a sort order of the sorted list.

The elements of the sorted list may comprise a structured data type comprising a plurality of attributes (e.g., at least one of a map or an array). The indication of the sort order may comprise an indication of the order the attributes of the structured data type are considered when sorting an array.

In an example embodiment, an NF Consumer (e.g., NRF) uses two new attributes (e.g., “sortedLists”, which is an example of an indication of the sorted list, and “dataStructureSortOrder”, which is an example of an indication of a sort order of the sorted list) in the NFProfile it registers to the NRF that accordingly indicate which of the lists are sorted—and thus non-linear search algorithms can be applied and the order the attributes of a structured data type are considered in the sorting of an array list.

In an example embodiment, when an NRF, an SCP or other NF is searching within an NFProfile, if there is no indication that the lists in the NFProfile are sorted the NRF or NFs/SCPs search the list linearly/sequentially as per current implementation and if the NFProfile indicates that the list is sorted, the NRF or NFs/SCP search in the list using non-linear search algorithms, based on (e.g., taking into account) the order the attributes of a structured data types are considered in the sorting of an array list if an indication is provided.

Table 1 shows an example of an NFProfile, which includes the attributes “sortedLists” and “dataStructureSortOrder”.

TABLE 1

| Attribute name | Data type | P | Cardinality | Description |
|---|---|---|---|---|
| nfInstanceId | NfInstanceId | M | 1 | Unique identity of the NF Instance. |
| nfType | NFType | M | 1 | Type of Network Function |
| nfStatus | NFStatus | M | 1 | Status of the NF Instance (NOTE 5) (NOTE 16) |
| . . . | . . . | . . . | . . . | . . . |
| sortedLists | array(string) | O | 1 . . . N | List of JSON Pointers (as specified in IETF RFC |
| | | | | 6901) of list attributes (i.e., maps or arrays) in the NF |
| | | | | Profile. |
| | | | | Presence of an attribute in the array indicates that |
| | | | | the elements included in the list are sorted in |
| | | | | ascending order. |
| | | | | If a list attribute is not in the array, it shall be |
| | | | | assumed that the list may not be sorted. |
| dataStructureSort | map(array(string)) | O | 1 . . . N | Map of data structure attributes and an array |
| Order | | | | including the attributes they contain or a subset |
| | | | | thereof. |
| | | | | The key of the map is the data structure attribute |
| | | | | name. |
| | | | | The value of each entry of the map is an array |
| | | | | including attributes of the data structure in the order |
| | | | | they were used to sort the list. It is possible that the |
| | | | | array includes only a subset of the data structure's |
| | | | | attributes (if some of them were not used for sorting). |
| | | | | The map shall contain all data structure attributes |
| | | | | that are used in sorted arrays. Data structure |
| | | | | attributes included in sorted maps do not need to be |
| | | | | included. |

An NRF Consumer may, for example, sort the attributes of the lists that are marked as sorted in the following manner.

When the structured data type comprises a map, the elements may be sorted in ascending (or descending) order based on a key of the map

If the list is an array, and the elements are simple data types then the elements may be sorted in ascending (or descending) order. Booleans may be handled as strings (e.g., “false” is placed before “true”). Attributes that are (e.g., shall) be handled in a case insensitive manner may (e.g., shall) accordingly be sorted as case insensitive order (e.g. “abc” shall precede “ZZZ” even though lexicographically capital letters “Z” precede non capital letter “a”)

If the elements of the array are a data structure, then the elements may be placed in ascending (or descending) order in accordance with the information provided in the relevant entry of the dataStructureSortOrder.

The indication of the sort order may comprise an indication that the order is ascending or descending.

For example, if the array consists of slices (ExtSnssai) and the relevant entry on the dataStructureSortOrder is {“ExtSnssai”: [“sst”, “sd”, “sdRanges”} they may (e.g., shall) be sorted in ascending order first based on their “sst”, and if there are multiple entries with the same sst, then according to the “sd” and of there are still multiple entries with the same value then according to the “sdRanges”.

If the element does not include an optional attribute, it may be sorted first in regard to that specific attribute. For example, a ExtSnssai has a “sst” but no “sd” it shall be placed before a ExtSnssai for the same “sst” which however has a “sd”.

If the element does include an attribute (but its value is “null”), it is sorted after the elements that do not include the attribute (but before any element with non-null in regard to that specific attribute). For example, if all other attributes with higher score precedence are equal, a structured data, which is sorted based on “5QiRm” (which, e.g., is nullable), will place first of a elements that do not have the relevant attribute at all, then the elements that have the attribute with value “null” and last the elements that have any number for that attribute.

The indication of the sort order may indicate that the array is used for sorting. If the data structure contains an array, and it is indicated that the array is used for sorting then the array itself may (e.g., shall) be sorted and explicitly given as one of the “sortedLists” (as per example above ([“/sNssai”, “/sNssai/SdRange”])

Arrays may be used as sorting attributes based on of their respective entries. For example, the first element of array A is compared with the first element of array B. If they both have same value for the first element, then the second element of the array A is compared with the second element of the array B and so on. If an array does not have an entry in a specific position, it may (e.g., shall) be ordered as first compared to another array that has an entry in that position.

It is possible that the only a subset of the data structure attributes is used for sorting (as per example above with the “wildcardSd” or e.g., if the attribute is a regular expression pattern for which sort ordering is not useful). In that case, the non-linear search algorithm cannot be based on non-sorted attributes.

It is possible that sorting is based on optional attributes of the data structure that are unknown to the NF Profile Consumer (because e.g., NF Producer implements a newer version of the API the consumer does not support). In that case, the NF Profile consumer may apply linear search. The NF Profile consumer can recognize this situation by identifying an unknown attribute in the dataStructureSortOrder map entry array corresponding to the data structure.

Since dataStructureSortOrder contains a data structure only once, all arrays using that data structure for sorting may follow the same attribute sorting order.

While the elements of the list are ordered based on (e.g., taking into account) certain attributes in a specified order, as per 3GPP guidelines the attributes themselves do not need to be placed in a same order within the structured datatype. For example, a sorted TAI list may sort the TAIs first based on the “plmnId” then the “nid” and last the “tac”. Nevertheless, it is possible that the TAI elements are actually placed in different order in the data structure (e.g., first “plmnId” then “tac” and third “nid”). If the attributes are in the same order they are used for sorting as it may make the search faster.

A sort order may be preconfigured at the apparatus. For example, alternative ways to sort data structures in an interoperable manner are to follow the order they are defined in the JSON object definition, use alphabetical order of the attribute name or standardize the order each attribute of the data structure is used for sorting in 3GPP specifications. These alternatives may impose a predefined sort order of the attributes thus may make implementation easier. However, providing an indication of sort order may be more flexible.

It may be possible to implement the same method in additional APIs, when search in large lists is frequently employed (e.g., or otherwise required).

The method may be used even if the Producer registering its profile to NRF does not support it. In this case, the NRF may sort selected lists of the NFProfile, and populates them as sorted lists when providing the Producer's NFProfile to NF Consumers.

By using non-linear search algorithms, the computational steps to search in NFProfile lists with very large number of elements can be decreased, thereby optimising the search process.

The method may provide flexibility. Since indication regarding sorting is per list, the NF has the option to sort only selected lists (e.g., large lists). Also, the NF Producer may determine if sorting should be applied only in a subset of the attributes of data structures contained in arrays.

The method may be backwards compatible. If either the consumer or the NRF do not support this functionality, sequential/linear search is automatically applied. Furthermore, it is possible to gain some of the benefits of the method even if the NRF does not support it, as long as the NRF transparently conveys the introduced attributes from the NF Producer to the NF Consumers/SCPs.

An apparatus may comprise means for determining at least one sorted list of elements from a plurality of lists of elements and means for providing information comprising the at least one sorted list to a network function, the information comprising an indication of the sorted list.

The apparatus may comprise a further network function, be the further network function or be comprised in the further network function or a chipset for performing at least some actions of/for the further network function. In some example embodiments, the apparatus may be configured to operate as the further network function. For instance, the apparatus may be configured to perform one or more functions of the further network function.

Alternatively, or in addition, an apparatus may comprise means for receiving information at a network function, the information comprising at least one sorted list of elements and an indication of the sorted list and means for performing a search of the elements of the sorted list using a non-linear search algorithm.

The apparatus may comprise the network function, be the network function or be comprised in the network function or a chipset for performing at least some actions of/for the network function. In some example embodiments, the apparatus may be configured to operate as the network function. For instance, the apparatus may be configured to perform one or more functions of the network function.

It should be understood that the apparatus may comprise or be coupled to other units or modules etc., such as radio parts or radio heads, used in or for transmission and/or reception. Although the apparatus have been described as one entity, different modules and memory may be implemented in one or more physical or logical entities.

It is noted that whilst some example embodiments have been described in relation to 5G networks, similar example embodiments can be applied in relation to other networks and communication systems, such as 6G networks or 5G-Advanced networks. Therefore, although certain embodiments were described above, by way of non-limiting and illustrative examples with reference to certain example architectures for wireless networks, technologies and standards, example embodiments may be applied to any other suitable forms of communication systems than those illustrated and described herein.

It is also noted herein that while the above describes various example embodiments of the subject disclosure, there are several variations and modifications that may be made to the various example embodiments without departing from the scope of the subject disclosure.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. As used herein, the term “and/or” includes any and all combinations of one or more of the listed terms.

In general, the various embodiments may be implemented in hardware or special purpose circuitry, software, logic or any combination thereof. Some aspects of the disclosure may be implemented in hardware, while other aspects may be implemented in firmware or software that may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following example embodiments:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that utilize software (e.g., firmware) for operation, but the software may not be present when it is not utilized for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out any of the example embodiments. The one or more computer-executable components may be at least one software code or portions of it.

Further, in this regard it should be noted that any blocks of the logic flow as in the FIGS. may represent program steps, or interconnected logic circuits, blocks and functions, or a combination of program steps and logic circuits, blocks and functions. The software may be stored on media such physical media as memory chips, or memory blocks implemented within the processor, magnetic media, such as hard disk or floppy disks, and optical media, such as for example DVD and the data variants thereof, CD. The physical media is a non-transitory media. The term “non-transitory,” as used herein, is a limitation of the medium itself (e.g., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting and illustrative examples.

The example embodiments of the subject disclosure may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for the various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the various example embodiments of this subject disclosure. However, various modifications and adaptations may become apparent to those skilled in the relevant arts in view of the foregoing description, when read in conjunction with the accompanying drawings and the claims. However, all such and similar modifications of the teachings of the various example embodiments will still fall within the scope of the subject disclosure as defined in the claims. Indeed, there is a further example embodiment comprising a combination of one or more example embodiments with any of the other example embodiments described herein.

1.-27. (canceled)

28. An apparatus comprising:
means for determining at least one sorted list of elements from a plurality of lists of elements; and
means for providing information comprising the at least one sorted list to a network function, the information comprising an indication of the sorted list.

29. The apparatus according to claim 28, wherein the information comprises an indication of a sort order of the sorted list.

30. The apparatus according to claim 29, wherein the elements of the sorted list comprise a structured data type comprising a plurality of attributes and the indication of the sort order comprises an indication of the order the attributes of the structured data type are considered in the sorted list.

31. The apparatus according to claim 30, wherein the structured data type comprises at least one of a map or an array.

32. The apparatus of claim 31, wherein the structured data type comprises at least one of:
a map and the elements are sorted in ascending or descending order based on a key of the map, or
an array, the elements of the array are simple data types and the elements are sorted in ascending or descending order, or
an array, the elements of the array comprise a further structured data type and the elements are sorted in ascending or descending order based on the indication of the sort order.

33. The apparatus according to claim 32, wherein the indication of the sort order indicates that the array is used for sorting.

34. The apparatus according to claim 32, wherein the indication of the sort order comprises an indication that the order is ascending or descending.

35. The apparatus according to claim 28, wherein a sort order is preconfigured at the apparatus.

36. An apparatus comprising:
means for receiving information at a network function, the information comprising at least one sorted list of elements and an indication of the sorted list; and
means for performing a search of the elements of the sorted list using a non-linear search algorithm.

37. The apparatus according to claim 36, wherein the information comprises an indication of a sort order of the sorted list.

38. The apparatus according to claim 37, wherein the elements of the sorted list comprise a structured data type comprising a plurality of attributes and the indication of the sort order comprises an indication of the order the attributes of the structured data type are considered in the sorted list.

39. The apparatus according to claim 38, wherein the structured data type comprises at least one of a map or an array.

40. The apparatus of claim 39, wherein the structured data type comprises at least one of:
a map and the elements are sorted in ascending or descending order based on a key of the map, or
an array, the elements of the array are simple data types and the elements are sorted in ascending or descending order, or
the elements of the array comprise a further structured data type and the elements are sorted in ascending or descending order based on the indication of the sort order.

41. The apparatus according to claim 40, wherein the indication of the sort order indicates that the array is used for sorting.

42. The apparatus according to claim 40, wherein the indication of the sort order comprises an indication that the order is ascending or descending.

43. The apparatus according to claim 36, wherein the apparatus comprises at least one of:
a network repository function and comprising means for receiving the information from a network function service producer, or
a network function service consumer or service communication proxy and comprising means for receiving the information from a network repository function.
